(19) United States
(12) Patent Application Publication
(10) Pub. No.: US 2006/0281190 A1
(43) Pub. Date: Dec. 14, 2006

(54) Analyte detection using luminescence concentration

(76) Inventors: Rene P. Helbing, Loveland, CO (US); Bo U. Curry, Loveland, CO (US)

Correspondence Address: AVAGO TECHNOLOGIES, LTD., P.O. BOX 1920, DENVER, CO, 80201-1920, US

(21) Appl. No.: 11/148,622

(22) Filed: Jun. 9, 2005

(51) Int. Cl. G01N 21/64

(52) U.S. Cl. 436/172

(57) ABSTRACT

A detection system includes a sensor structure, a luminescence concentrator and a detector. The sensor structure indicates presence of an analyte in a sample by production of light. The luminescence concentrator receives light from the sensor structure and concentrates the light from the sensor structure to increase brightness. The detector detects brightness of light as received from the luminescence concentrator.

### BACKGROUND

Some test systems are constructed to detect the presence or absence of an analyte by the presence of light resulting from luminescence or fluorescence. For example, some tests rely on chemoluminescence to detect an analyte. A standard example of chemoluminescence is the test of a sample for the presence of blood by bringing the sample in contact with Luminol and checking for existence of light from chemoluminescence.

Alternatively, other tests rely on fluorescence to detect an analyte. For example, a sample including single stranded DNA and fluorescent dye is introduced into a sensor chamber that includes immobilized strands of DNA. When there is a match between the single stranded DNA in the sample, and the immobilized strands of DNA, hybridization takes place between the single stranded DNA in the sample and the immobilized strands of DNA. The fluorescent dye binds (and only binds) to the hybridized DNA. The level of fluorescence provides a quantitative indication of the presence of the target DNA in the sample.

In many tests, light available from chemoluminescence and/or fluorescence is relatively dim. Detection of the presence and quantity of light using a standard photodetector can therefore be difficult. Additionally, the most typical reaction agent used in chemoluminescence testing emits light having a wavelength in the vicinity of 435 nanometers, which is a wavelength at which photodiodes are typically not very efficient. Increasing the detection area of the strip or the volume of the sensor chamber increases the amount of generated light but also increases the area of the photo detector, which increases the noise associated with a detection signal. In addition, more detection volume also requires increased amounts of reagents and targets.

### SUMMARY OF THE INVENTION

In accordance with an embodiment of the present invention, a detection system includes a sensor structure, a luminescence concentrator and a detector. The sensor structure indicates presence of an analyte in a sample by production of light. The luminescence concentrator receives light from the sensor structure and concentrates the light from the sensor structure to increase brightness. The detector detects brightness of light as received from the luminescence concentrator.

### BRIEF DESCRIPTION OF THE DRAWINGS

FIG. 1 shows an analyte detection system using a luminescence concentrator in accordance with an embodiment of the present invention.

FIG. 2 shows an analyte detection system using a luminescence concentrator in accordance with another embodiment of the present invention.

FIG. 3 shows an analyte detection system using a luminescence concentrator in accordance with another embodiment of the present invention.

### DESCRIPTION OF THE EMBODIMENT

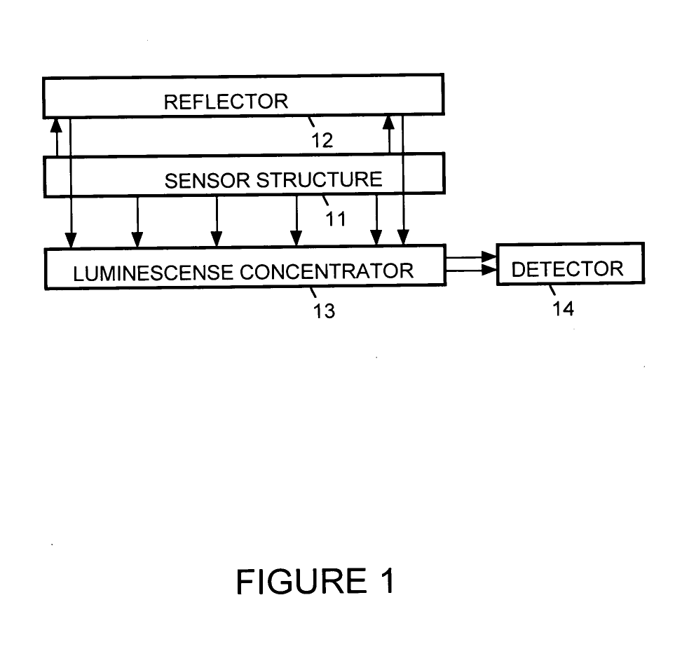

FIG. 1 shows an analyte detection system. The analyte detection system includes a sensor structure 11 that is used to test a sample to determine the presence of one or more analytes. Presence (or alternatively absence) and/or concentration of an analyte are indicated based on the quantity of light detected within a prescribed wavelength range. For example, sensor structure 11 is a capillary, sensor chamber, test strip or some other structure that is used for sensing the presence or absence of an analyte.

For example, the presence and/or concentration of analyte are indicated by light produced by chemoluminescence. Alternatively, the presence and/or concentration of analyte are indicated by light produced by fluorescence.

Light from sensor structure 11 radiates to a luminescence concentrator 13 that collects and concentrates light energy. For example, luminescent concentrator 13 is a planar optical matrix embedded with light emitting molecules such as fluorescent or luminescent dye or quantum dots. Photons incident on the luminescent concentrator are absorbed by the light emitting molecules. The light emitting molecules emit new photons, a large portion of which are contained within the luminescent concentrator and are guided to the edges of the luminescent concentrator by total internal reflection.

A light detector 14 detects light concentrated by luminescence concentrator 13. For example, light detector 14 is a photodetector. Luminescence concentrator 13 increases the brightness of light generated by sensor structure 11 and increases the effectiveness of light detector 14 to detect and measure intensity of the light.

Optionally, a reflector 12 can be utilized to intercept light radiated by sensor structure 11 away from concentrator 13, and to redirect the intercepted light back to concentrator 13.

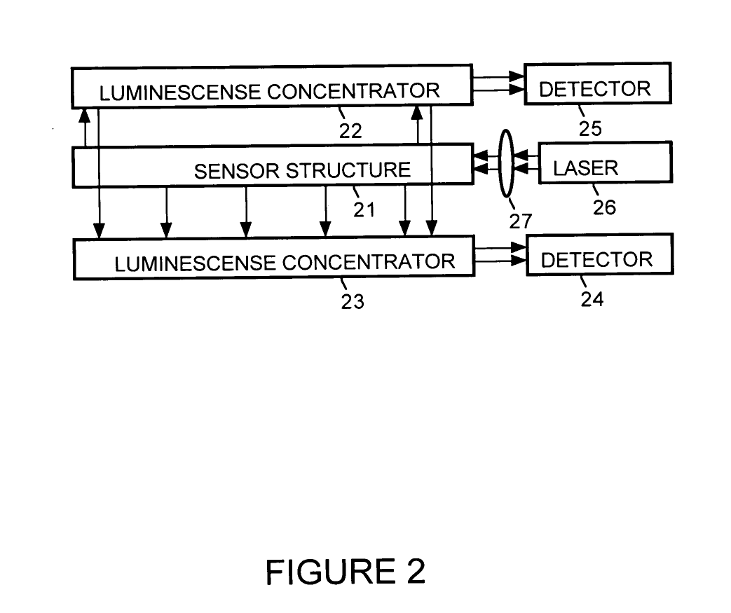

FIG. 2 shows another embodiment of an analyte detection system. The analyte detection system includes a sensor structure 21 that is used to test a sample to determine the presence of one or more analytes. Presence (or alternatively absence) and/or concentration of an analyte are indicated based on the quantity of light detected within a prescribed wavelength range. For example, sensor structure 21 is a capillary, sensor chamber, test strip or some other structure that is used for sensing the presence or absence of an analyte.

For example, the presence and/or concentration of analyte are indicated by light produced by fluorescence. A laser 26 through lenses 27 places light within sensor structure 21. Fluorescent molecules bounded to analyte will radiate light with a detection wavelength that is different than the wavelength of light produced by laser 26.

Light from sensor structure 21 radiates to a luminescence concentrator 23 that collects and concentrates light energy. For example, luminescent concentrator 23 is a planar optical matrix embedded with light emitting molecules such as fluorescent or luminescent dye or quantum dots. Photons incident on the luminescent concentrator at the detection wavelength are absorbed by the light emitting molecules. The light emitting molecules emit new photons, a large portion of which are contained within the luminescent concentrator and are guided to the edges of the luminescent concentrator by total internal reflection.

A light detector 24 detects light concentrated by luminescence concentrator 23 at the detection wavelength. For example, light detector 24 is a photodetector. Luminescence concentrator 23 increases the brightness of light generated by sensor structure 21 and increases the effectiveness of light detector 24 to detect and measure intensity of the light at the detection wavelength.

Instead of a reflector, a second luminescence concentrator 22 is utilized to intercept light radiated by sensor structure 21 toward luminescence concentrator 22. A light detector 25 detects light concentrated by luminescence concentrator 22. For example, light detector 25 is a photodetector. Luminescence concentrator 22 increases the brightness of light generated by sensor structure 21 and increases the effectiveness of light detector 25 to detect and measure intensity of the light at the detection wavelength.

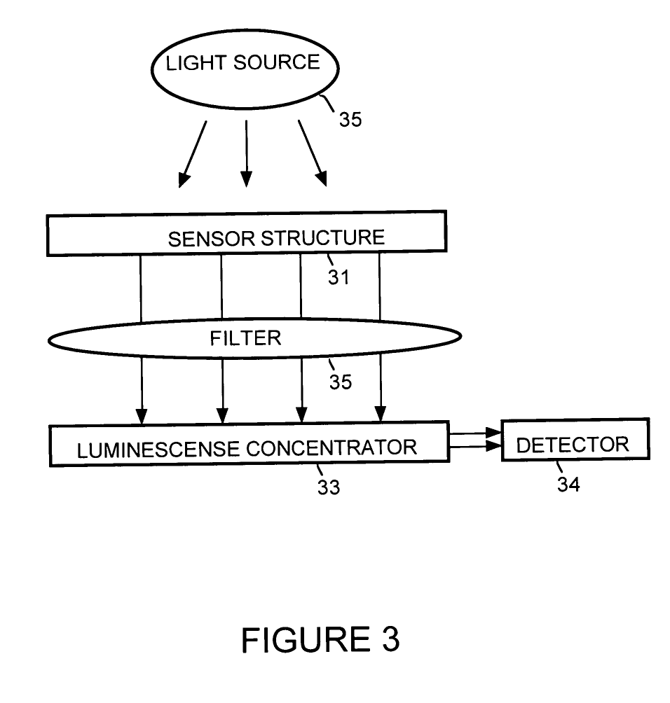

FIG. 3 shows another embodiment of an analyte detection system. The analyte detection system includes a sensor structure 31 that is used to test a sample to determine the presence of one or more analytes. Presence (or alternatively absence) and/or concentration of an analyte are indicated based on the quantity of light detected within a prescribed wavelength range. For example, sensor structure 31 is a capillary, sensor chamber, test strip or some other structure that is used for sensing the presence or absence of an analyte.

For example, the presence and/or concentration of analyte are indicated by light produced by a light source 35. Light source 35 can be, for example, room lighting or even outdoor lighting provided by the sun.

Light from sensor structure 31 radiates through a filter 35 to a luminescence concentrator 33 that collects and concentrates light energy. For example, luminescent concentrator 33 is a planar optical matrix embedded with light emitting molecules such as fluorescent or luminescent dye or quantum dots. Photons incident on the luminescent concentrator at the detection wavelength are absorbed by the light emitting molecules. The light emitting molecules emit new photons, a large portion of which are contained within the luminescent concentrator and are guided to the edges of the luminescent concentrator by total internal reflection.

A light detector 34 detects light concentrated by luminescence concentrator 33 at the detection wavelength. For example, light detector 34 is a photodetector. Luminescence concentrator 33 increases the brightness of light generated by sensor structure 31 and increases the effectiveness of light detector 34 to detect and measure intensity of the light at the detection wavelength.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A detection system comprising:
a sensor structure that indicates presence of an analyte in a sample by production of light;
a luminescence concentrator that receives light from the sensor structure and concentrates the light from the sensor structure to increase brightness; and,
a detector that detects brightness of light as received from the luminescence concentrator.

2. A detection system as in claim 1 wherein the sensor structure is one of the following:
capillary;
sensor chamber;
test strip.

3. A detection system as in claim 1 wherein the sensor structure produces light using chemoluminescence.

4. A detection system as in claim 1 wherein the sensor structure produces light using fluorescence.

5. A detection system as in claim 1 additionally comprising:
a reflector, the reflector reflecting to the luminescence concentrator light that radiates from the sensor structure in a direction away from the luminescence concentrator.

6. A detection system as in claim 1:
wherein the luminescence concentrator is a first luminescence concentrator;
wherein the detector is a first detector; and,
wherein the detection system additionally comprises:
a second luminescence concentrator that receives light from the sensor structure and concentrates the light from the sensor structure to increase brightness, and
a second detector that detects brightness of light as received from the second luminescence concentrator.

7. A detection system as in claim 1 additionally comprising:
a light source that illuminates the sensor structure to allow generation of light by the sensor structure utilizing fluorescence.

8. A method for detecting an analyte, the method comprising:
indicating presence of an analyte in a sample by production of light;
receiving the produced light and using a luminescence concentrator to increase brightness of the produced light; and,
detects brightness of the produced light after the brightness of the produced light has been increased by the luminescence concentrator.

9. A method as in claim 8 wherein presence of the analyte is indicated by one of the following:
capillary;
sensor chamber;
test strip.

10. A method as in claim 8 wherein the production of light is performed by chemoluminescence.

11. A method as in claim 8 wherein the production of light is performed by fluorescence.

12. A method as in claim 8 additionally comprising:
reflecting to the luminescence concentrator light that radiates in a direction away from the luminescence concentrator.

13. A method as in claim 8 additionally comprising:
receiving the produced light by a second luminescence concentrator and using the second luminescence concentrator to increase brightness of the produced light; and,
detecting brightness of the produced light after the brightness of the produced light has been increased by the second luminescence concentrator.

14. A method as in claim 8 additionally comprising:
illuminating the sensor structure to allow generation of light by the sensor structure utilizing fluorescence.

15. A detection system comprising:
sensor means for indicating presence of an analyte in a sample by production of light;
concentrator means for receiving light from the sensor means and concentrating the light from the sensor means to increase brightness; and,
detecting means for detecting brightness of light as received from the concentrator means.

16. A detection system as in claim 15 wherein the sensor means is one of the following:
capillary;
sensor chamber;
test strip.

17. A detection system as in claim 15 wherein the sensor means produces light using one of the following:
chemoluminescence;
fluorescence.

18. A detection system as in claim 15 additionally comprising:
reflector means for reflecting to the concentrator means light that radiates from the sensor means in a direction away from the concentrator means.

19. A detection system as in claim 15:
wherein the concentrator means is a first concentrator means;
wherein the detecting means is a first detecting means; and,
wherein the detection system additionally comprises:
second concentrator means for receiving light from the sensor means and concentrating the light from the sensor means to increase brightness, and
second detecting means for detecting brightness of light as received from the second concentrator means.

20. A detection system as in claim 15 additionally comprising:
light source means for illuminating the sensor means to allow generation of light by the sensor means utilizing fluorescence.
